(19) United States
(12) Patent Application Publication
(10) Pub. No.: US 2024/0414408 A1
(43) Pub. Date: Dec. 12, 2024

(54) AUDIO OR LIGHTING ADJUSTMENT BASED ON IMAGES

(71) Applicants: Robert Kall, Akron, OH (US); Jonathan Goodman, North Castle, NY (US)

(72) Inventors: Robert Kall, Akron, OH (US); Jonathan Goodman, North Castle, NY (US)

(21) Appl. No.: 18/332,696

(22) Filed: Jun. 9, 2023

(51) Int. Cl. H04N 21/485; G06V 10/60; G06V 20/52; G06V 40/16; G06V 40/20; H04N 21/2187; H04N 21/439

(52) U.S. Cl. CPC H04N 21/4852; G06V 10/60; G06V 20/53; G06V 40/174; G06V 40/20; H04N 21/2187; H04N 21/4394

(57) ABSTRACT

In some implementations, a device may obtain a sequence of images of a physical area. At least one image of the sequence of images may be captured during playback of audio at the physical area. The device may extract one or more images of the sequence of images. The one or more images may depict one or more people present at the physical area. The device may cause, in accordance with an output of computer vision processing of the one or more images, an adjustment to the playback of the audio.

### BACKGROUND

Audio, such as music, may be output through speakers. The audio can be playback of previously-recorded audio or a live performance.

### SUMMARY

In some implementations, a system includes one or more speakers, one or more cameras, and a control device. The control device may be configured to obtain a sequence of multiple images of a physical area captured by the one or more cameras during playback of audio, via the one or more speakers, at the physical area. The control device may be configured to extract one or more images from the sequence of multiple images, where the one or more images depict one or more people present at the physical area. The control device may be configured to provide the one or more images to a machine learning model, where the machine learning model is trained to determine a change of a volume of the audio, a change of a tempo of the audio, a change of a genre of the audio, or a change of an audio track of the audio based on an input of the one or more images. The control device may be configured to transmit a signal for the one or more speakers to cause the one or more speakers to output an adjustment to the playback of the audio that is based on an output of the machine learning model.

In some implementations, a method may include obtaining, by a device, a sequence of images of a physical area, where at least one image of the sequence of images is captured during playback of audio at the physical area and depicts one or more people present at the physical area. The method may include generating, by the device, a signal in accordance with an output of computer vision processing of the at least one image. The method may include providing, by the device, the signal to audio output hardware to cause an adjustment to the playback of the audio.

In some implementations, a device may include one or more memories and one or more processors, coupled to the one or more memories. The one or more processors may be configured to obtain one or more images of a physical area captured during audio output through a speaker at the physical area, where the one or more images depict one or more people present at the physical area. The one or more processors may be configured to cause, based on the one or more images, an adjustment to at least one of the audio output or a lighting at the physical area.

### BRIEF DESCRIPTION OF THE DRAWINGS

FIGS. 1A-1D are diagrams of an example associated with audio or lighting adjustment based on images.

FIG. 2 is a diagram of an example environment in which systems and/or methods described herein may be implemented.

FIG. 3 is a diagram of example components of a device associated with audio or lighting adjustment based on images.

FIG. 4 is a flowchart of an example process associated with audio or lighting adjustment based on images.

### DETAILED DESCRIPTION

The following detailed description of example implementations refers to the accompanying drawings. The same reference numbers in different drawings may identify the same or similar elements.

An audio system may be used to output audio, such as music, through speakers or other audio output hardware. For example, an audio system may be used at a commercial setting, such as at a bar, a nightclub, or a restaurant, or at a personal setting, such as at a home, to output audio for an audience. Generally, there is a volume range of the audio that will be suitable for all or most members of a given audience. However, this volume range may vary from location to location as well as with respect to different audience compositions. Moreover, inefficiency is associated with playing audio too loud or too soft for a given audience.

For example, an audio system may consume excessive power by playing audio louder than needed or desired by a given audience. As another example, playing audio too softly also results in wasted power consumption, as the audio system is still consuming power, but the audio is not reaching the intended audience. Furthermore, playing audio that an audience finds unappealing results in wasted power consumption, as the audio system is still consuming power, but the audio content is unwanted by the audience. Some implementations described herein provide an audio system that can efficiently and dynamically manage audio output to optimize power consumption of the audio system.

In some examples, a lighting system may be used in connection with the audio system. For example, an optical output of the lighting system may be synchronized with, or otherwise accompany, an audio output of the audio system. Similarly as described above, using lighting that an audience finds unappealing results in wasted power consumption, as the lighting system is still consuming power, but the lighting is unwanted by the audience. Some implementations described herein provide a lighting system that can efficiently and dynamically manage lighting (e.g., optical output) to optimize power consumption of the lighting system.

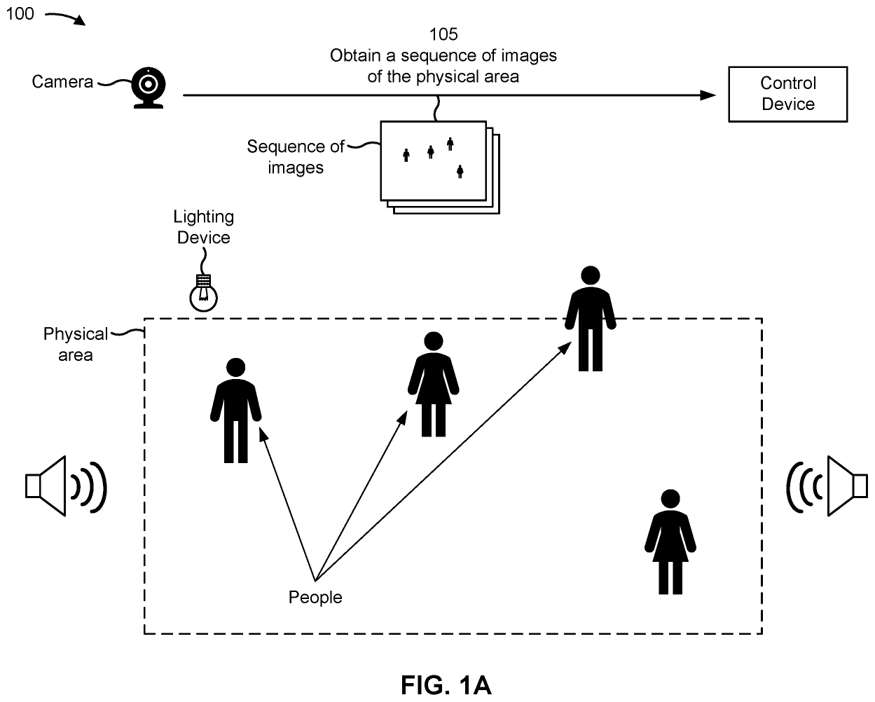

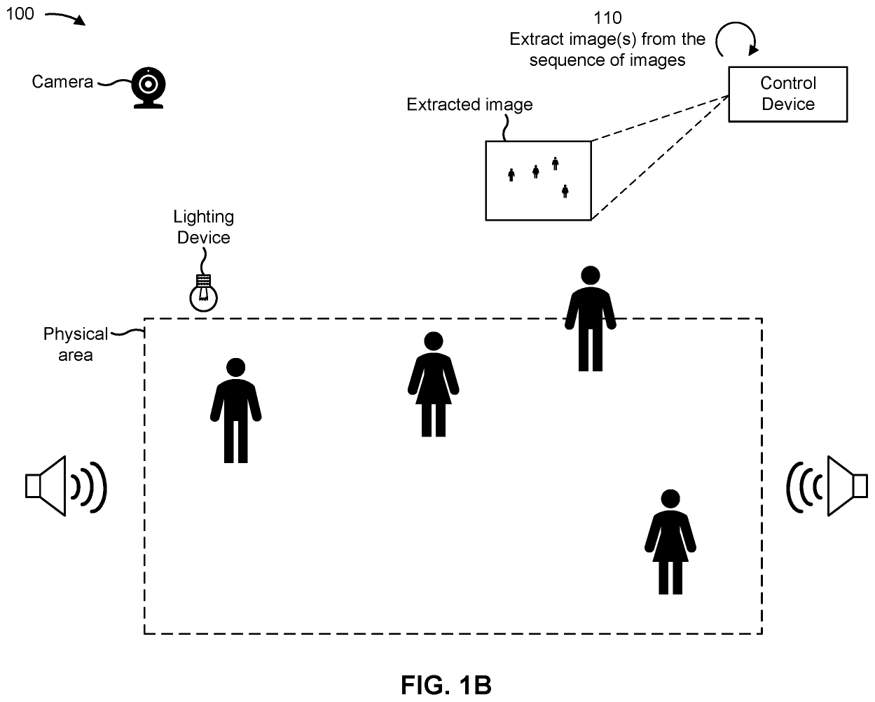

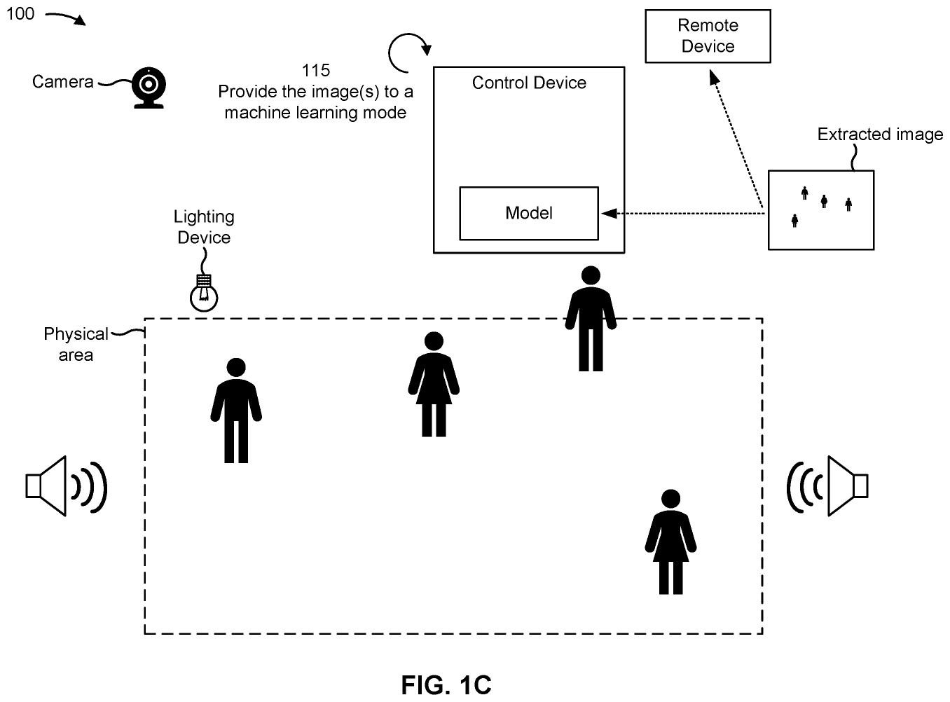

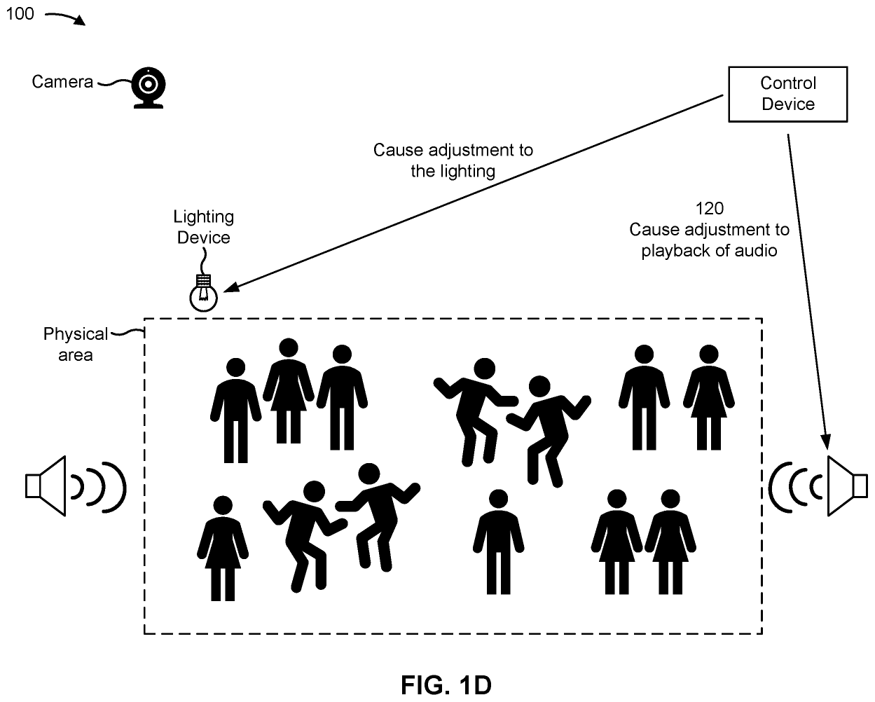

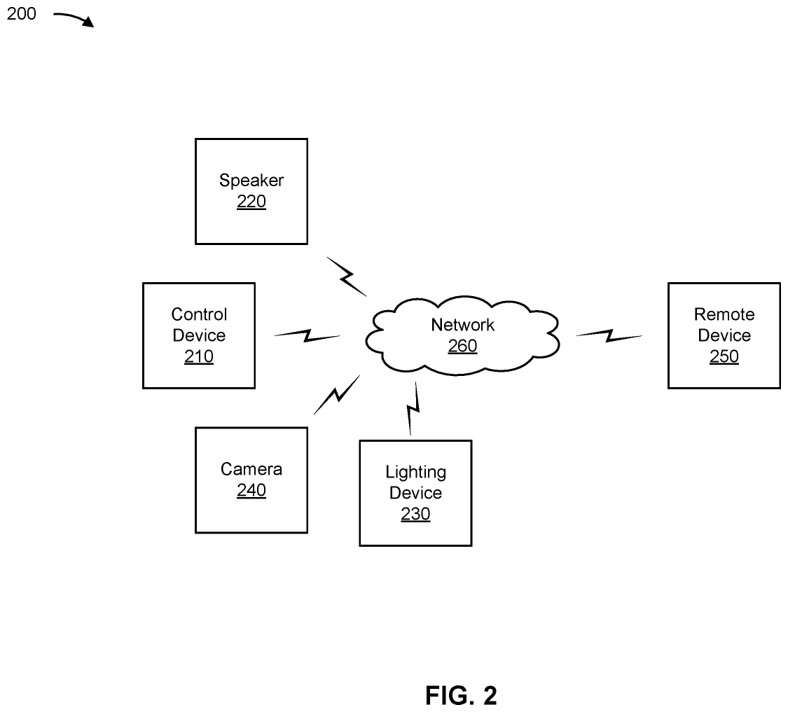

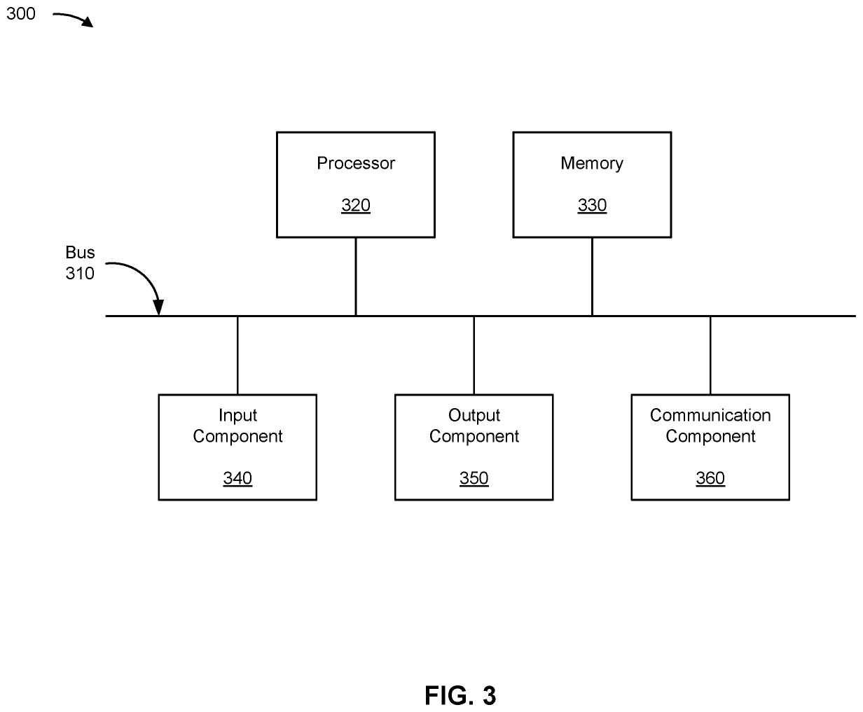

FIGS. 1A-1D are diagrams of an example 100 associated with audio or lighting adjustment based on images. As shown in FIGS. 1A-1D, example 100 includes a control device, which is described in more detail in connection with FIGS. 2 and 3.

The control device may be used to adjust audio and/or lighting at a physical area. The physical area may be a bar, a night club, a restaurant, a dance floor, a movie theater, or a house, among other examples. In some implementations, the control device may be communicatively coupled (e.g., wirelessly or using wires) with one or more cameras present at a physical area or otherwise directed at the physical area (e.g., to enable the control device to control and/or receive data from the one or more cameras). In some implementations, the control device may share a housing with a camera. In some implementations, the control device may be communicatively coupled (e.g., wirelessly or using wires) to one or more lighting devices (e.g., single light units and/or light arrays) present at the physical area or otherwise directed at the physical area (e.g., to enable the control device to control the one or more lighting components). In some implementations, the control device may share a housing with a lighting device. In some implementations, the control device may be communicatively coupled (e.g., wirelessly or using wires) to one or more speakers present at the physical area or otherwise directed at the physical area (e.g., to enable the control device to control or transmit signals to the one or more speakers). In some implementations, the control device may share a housing with a speaker. In some implementations, a system may include one or more speakers, one or more cameras, one or more lighting devices, and/or the control device.

In some implementations, the control device may store a plurality of audio tracks (e.g., audio files) and/or the control device may include an interface to enable the control device to load or otherwise access audio tracks stored on another device. The audio tracks may be associated with metadata indicating, for each audio track, a title of the audio track, a genre of the audio track, a playback time of the audio track, a tempo (e.g., a predominant tempo) of the audio track, a musical key (e.g., a predominant musical key) of the audio track, and/or a lighting configuration for the audio track. In some implementations, the control device may generate the metadata (e.g., indicating playback times, tempos, and/or musical keys) by scanning the audio tracks. For example, the control device may scan an audio file using an audio analysis technique that includes analyzing a waveform associated with the audio file. The audio analysis technique may include analyzing the waveform of the audio file to identify time points where beats occur to thereby identify tempo (which may be referred to as “beat detection”). Additionally, or alternatively, the audio analysis technique may include analyzing a harmonic content of the audio file to identify a predominant musical key (which may be referred to as “key detection”).

As shown in FIG. 1A, and by reference number 105, the control device may obtain a sequence of images of the physical area. For example, the control device may obtain the sequence of images from the one or more cameras present at the physical area or otherwise directed at the physical area. The one or more cameras may be associated with the physical area (e.g., mounted on walls of the physical area) or associated with people present at the physical area (e.g., the sequence of images may be crowdsourced from one or more user devices of the people). The sequence of images may be video, or images captured in sequence at regular intervals (e.g., every 0.5 seconds, every 1 second, or the like) or irregular intervals. For example, the sequence of images may be a live video feed of the physical area. The sequence of images may include at least one image (e.g., a plurality of images) captured during playback of audio at the physical area or during outputting of live audio (e.g., a musical performance) at the physical area (which may collectively be referred to as “audio output”). For example, the audio may be output through one or more speakers at the physical area. The audio may be music, audio accompanying a video, or another type of audio.

As shown in FIG. 1B, and by reference number 110, the control device may extract one or more images from the sequence of images. The one or more images may depict one or more people present at the physical area. Extracting an image from the sequence of images may include obtaining an image frame from the sequence of images. In some implementations, to extract the one or more images, the control device may extract samples from the sequence of images (e.g., extract image frames at a rate less than a frame rate of the sequence of images) or extract every image from the sequence of images (e.g., extract image frames at a frame rate of the sequence of images). In some implementations, the control device may perform an object detection technique on the sequence of images to identify images that depict at least one person, and the one or more images that the control device extracts from the sequence of images may include the images that depict at least one person. Additionally, or alternatively, the control device may also obtain audio data that accompanies the sequence of images, and the control device may perform an analysis of the audio data to identify images that were captured during the playback of audio or during live audio (e.g., as opposed to images that were captured during mere audience noise). In some implementations, the control device may perform pre-processing of the one or more images that are extracted. The pre-processing may include brightness adjustment, noise removal, grayscale conversion, image compression, and/or cropping, among other examples. As described herein, the control device may determine an adjustment to the audio and/or the lighting based on the one or more images.

As shown in FIG. 1C, and by reference number 115, the control device may provide the one or more images to a machine learning model. In some implementations, the machine learning model may be implemented on the control device, and to provide the one or more images to the machine learning model, the control device may input the one or more images to the machine learning model. In some implementations, the machine learning model may be implemented on a remote device (e.g., on a device of a cloud computing environment, on a remote server, or the like), and to provide the one or more images to the machine learning model, the control device may transmit the one or more images to the remote device. In some implementations, the control device may provide additional information to the machine learning model, such as information indicating a current volume level of the audio, a current volume level at the physical area (e.g., due to people talking), a music genre associated with the physical area (e.g., the physical area may be a country-western themed bar), a current revenue amount (e.g. point-of-sale data) associated with the physical area (e.g., over a previous 10 minutes, half hour, hour, or the like), an audio style preference (e.g., a genre preference, a tempo preference, a key preference, or the like) of an operator (e.g., a DJ) of the control device (e.g., based on historical song selections of the operator), and/or one or more audience requests (e.g., relating to particular audio tracks and/or particular music genres, and the requests may be indicated by inputs to a user device and the user device may transmit the requests to the control device), among other examples.

The machine learning model may perform computer vision processing of the one or more images. The computer vision processing may include processing of the one or more images in connection with object detection, motion analysis, facial recognition, facial emotion detection, and/or object tracking, among other examples. In some implementations, the machine learning model may be trained to identify, in the one or more images, a crowd density of the one or more people depicted in the one or more images. For example, the crowd density may indicate a closeness of the people to one another. Additionally, or alternatively, the machine learning model may be trained to identify, in the one or more images, positions of the one or more people relative to one or more speakers of the physical area. For example, a person standing further from a speaker may indicate that a volume of the audio is too loud, whereas a person standing closer to a speaker may indicate that a volume of the audio is too soft. Additionally, or alternatively, the machine learning model may be trained to identify, in the one or more images, movement intensity levels of the one or more people. For example, a movement intensity level of a person may indicate a speed at which the person is moving, a speed at which arms (e.g., hands) and/or legs (e.g., feet) of the person are moving, a distance that the person travels over a particular time period, and/or a distance that arm movements and/or leg movements of the person travel over a particular time period. Additionally, or alternatively, the machine learning model may be trained to identify, in the one or more images, interaction proximities between the one or more people. For example, an interaction proximity may indicate a distance between two or more people that are interacting with each other (e.g., speaking with each other, dancing with each other, or the like). Additionally, or alternatively, the machine learning model may be trained to identify, in the one or more images, facial expression-based sentiments of the one or more people. For example, a facial expression-based sentiment of a person may indicate whether a person appears happy (e.g., because the person is smiling), whether a person appears bored (e.g., because the person is yawning), or the like.

Additionally, or alternatively, the machine learning model may be trained to identify, in the one or more images, physical characteristics of the one or more people (e.g., ages of the one or more people, genders of the one or more people, or the like). For example, the physical characteristics of the one or more people may indicate music genre preferences of the one or more people. Additionally, or alternatively, the machine learning model may be trained to identify, in the one or more images, clothing styles of the one or more people. For example, the clothing styles of the one or more people may indicate music genre preferences of the one or more people. Additionally, or alternatively, the machine learning model may be trained to identify, in the one or more images, dancing styles of the one or more people. For example, the dancing styles of the one or more people may indicate music genre preferences of the one or more people. Additionally, or alternatively, the machine learning model may be trained to identify, in the one or more images, characteristics of the physical area (e.g., a style of furniture, a decoration style, a luxuriousness, or the like). For example, the characteristics of the physical area may indicate a music genre preference of customers of the physical area or an appropriate volume for the physical area. Additionally, or alternatively, the machine learning model may be trained to identify noises made by the one or more people (e.g., laughing, talking, singing, or the like) and/or noise-based sentiment of the one or more people (e.g., singing along with the audio may indicate that the one or more people are satisfied with the audio).

The aforementioned variables that the machine learning model may identify in the images may be a feature set used by the machine learning model. Accordingly, an output of the machine learning model may be based on the feature set.

The machine learning model may use machine learning algorithms to process the one or more images and extract relevant features from the one or more images. The machine learning model may be trained using a set of training data. The training data may relate to the physical area and/or may relate to multiple different physical areas (e.g., a network of physical areas). The training data may include images and/or video of people at a physical area (e.g., a bar, a nightclub, or the like) during playback of audio. The images and/or video may be manually labeled (e.g., in connection with supervised learning) based on whether the people appear to be enjoying the audio. Moreover, the training data may include metadata associated with the images and/or video, such as data indicating a volume level of the audio playback, one or more characteristics of the audio playback (e.g., a music genre of the audio, the particular audio track being played, a musical key of the audio, a tempo of the audio, or the like), and/or a revenue amount associated with the physical area during playback of the audio (e.g., point-of-sale data), among other examples. The training data may be used to train the machine learning model, which may be based on various algorithms such as convolutional neural networks (CNNs), support vector machines (SVMs), or decision trees. In some implementations, the machine learning model may be trained using an unsupervised learning technique. In one example, the machine learning model may be a CNN.

The trained machine learning model may be used to analyze new images or video of people present at a physical location during playback of audio, such as the one or more images described herein. The machine learning model may detect and track the faces and bodies of the people in the images or video using techniques such as object detection and tracking. The machine learning model may analyze the detected faces and bodies to determine a crowd density (e.g., whether the crowd density is increasing or decreasing) and/or interaction proximities between people (e.g., whether interaction proximities are increasing or decreasing). Furthermore, the machine learning model may analyze facial expressions and/or body movements of each person to determine movement intensity levels (e.g., whether movement intensity levels are increasing or decreasing), sentiment (e.g., whether sentiment is becoming more positive or more negative), and/or dancing styles. Facial expression analysis may use techniques such as facial landmark detection and/or emotion recognition to identify key features such as smiles, frowns, and eyebrow movements. Body movement analysis may involve detecting changes in posture or movement patterns, such as head nodding or foot tapping. Additionally, the machine learning model may analyze the detected faces and bodies to determine physical characteristics of the one or more people and/or clothing styles of the one or more people. The machine learning model may also analyze audio data that accompanies the images/video (or audio data by itself) to identify particular noises (e.g., talking, laughing, or singing), noise-based sentiment (e.g., booing noise may indicate dissatisfaction), and/or a noise volume. The machine learning model may combine these features to make a prediction about whether the people are satisfied or dissatisfied with the audio (e.g., with the genre of the audio, with the particular audio track, with a volume of the audio, with a musical key of the audio, and/or with a tempo of the audio), whether the audio (e.g., a genre of the audio, a volume of the audio, a tempo of the audio, or the like) is appropriate for the physical area, or whether the audio is more likely to increase or decrease revenue of the physical area. The machine learning model may be trained to determine a change of a volume of the audio, a change of a tempo of the audio, a change of a key of the audio, a change of a genre of the audio, and/or a change of an audio track of the audio based on an input of the one or more images. Additionally, or alternatively, the machine learning model may be trained to determine a change to lighting based on the input of the one or more images.

An output of the machine learning model (e.g., of the computer vision processing) may indicate a suitability of the audio for the physical area (e.g., may indicate whether an audience at the physical area is responding favorably or unfavorably to the audio, or may indicate whether a revenue associated with the physical area is more likely to increase or decrease in connection with the audio). For example, the output may include a score, a set of scores, or another metric or metrics indicating the suitability of the audio. In some implementations, an output of the machine learning model (e.g., of the computer vision processing) may indicate a recommendation of an adjustment to the audio (e.g., based on a suitability of the audio for the physical area). For example, the recommendation may include a recommendation of a volume or a volume change of the audio, a recommendation of a tempo or a tempo change of the audio, a recommendation of a musical key or a musical key change of the audio, a recommendation of a musical genre, a recommendation of an audio track, and/or a recommendation of an audio effect. Additionally, or alternatively, an output of the machine learning model (e.g., of the computer vision processing) may indicate a recommendation of an adjustment to a lighting of the physical area (e.g., based on a suitability of the audio for the physical area). For example, the recommendation may include a recommendation of a light intensity or a light intensity change of the lighting, a recommendation of a color or a color change of the lighting, a recommendation of a lighting effect or a lighting effect change of the lighting, a recommendation of a beam width or a beam width change of the lighting, a recommendation to initiate or to stop spotting of the lighting, and/or a recommendation of a movement pattern or a movement pattern change of the lighting.

As shown in FIG. 1D, and by reference number 120, the control device may cause an adjustment to the playback of the audio (e.g., dynamically, in real time). For example, the control device may cause the adjustment to the playback of the audio based on the output of the machine learning model (e.g., of the computer vision processing). The adjustment to the playback of the audio may include a change of a volume of the audio, a change of a tempo of the audio, a change of a musical key of the audio, switching from a first audio track to a second audio track, and/or an overlaying or use of one or more audio effects on the audio. Additionally, or alternatively, the control device may cause an adjustment to lighting of the physical area (e.g., dynamically, in real time). For example, the control device may cause the adjustment to the lighting based on the output of the machine learning model (e.g., of the computer vision processing). The adjustment to the lighting may include increasing a light intensity of the lighting, decreasing a light intensity of the lighting, changing a color of the lighting, initiating or changing a movement pattern of the lighting, changing a beam width of the lighting, initiating or stopping spotting of the lighting, and/or initiating or changing an effect of the lighting (e.g., a strobe effect).

In some implementations, the control device may cause the adjustment to the playback of the audio and/or the lighting in accordance with a recommendation output by the machine learning model (e.g., the control device may select an audio track based on a music genre recommended by the machine learning model). In some implementations, the control device may determine the adjustment to the playback of the audio and/or the lighting based on the output of the machine learning model (e.g., based on a score(s) or a metric(s)). In some implementations, the control device may determine the adjustment as a function of the output (e.g., using an algorithm). For example, based on the machine learning model outputting a first score, the control device may increase the volume of the playback of the audio, and based on the machine learning model outputting a second score, the control device may decrease the volume of the playback of the audio. In some implementations, the control device may determine the adjustment to the playback of the audio using an additional machine learning model. For example, the control device may provide the output of the machine learning model (e.g., a score(s) or a metric(s) indicating a suitability of the audio for the physical area) to the additional machine learning model, and the additional machine learning model may output a recommendation of the adjustment to the playback of the audio and/or to the lighting.

In some implementations, the control device may cause a list of adjustment options to be presented on a display and/or the control device may transmit, to a user device, a message indicating the list of adjustment options. For example, if the output of the machine learning model indicates a recommendation of a music genre, the list of adjustment options may be a list of audio tracks associated with the music genre. In some implementations, the list may also indicate one or more success predictions (e.g., indicating a probability that the option will be suitable for the physical area) for each adjustment option (e.g., an adjustment option may have multiple success predictions for different levels of data, such as a platform-wide success prediction, a regional success prediction, or the like). The control device may receive an indication indicating a selection of an adjustment option from the list of adjustment options. Accordingly, the control device may cause the adjustment to the playback of the audio in accordance with the selection.

To cause adjustment of the audio, the control device may generate and provide (e.g., transmit) a signal (e.g., an electrical signal or a radio signal) to audio output hardware to cause the audio output hardware to output the audio in accordance with the adjustment. For example, the signal may indicate the adjustment or may correspond to the adjusted audio. As an example, the signal may cause the audio output hardware to output an adjustment to the audio that is based on the output of the machine learning model. The audio output hardware may be a speaker, a mixer, an amplifier, or the like. To cause adjustment of the lighting, the control device may generate and provide (e.g., transmit) a signal (e.g., an electrical signal or a radio signal) to a lighting device (e.g., a device that controls a light). For example, the signal may cause the lighting device to adjust the lighting at the physical area based on the output of the machine learning model. As an example, the lighting device may provide Internet of Things (IoT) capability or Bluetooth control of the light.

In some implementations, the control device may cause adjustment to the playback of the audio and/or the lighting based on audience feedback. For example, the audience may be informed of gestures (e.g., hand gestures, head gestures, facial expressions, or the like) that indicate particular feedback regarding the playback of the audio. As an example, a first gesture may indicate feedback to raise a volume, a second gesture may indicate feedback to lower a volume, a third gesture may indicate feedback to change the audio to a particular genre, a fourth gesture may indicate feedback to increase a tempo of the audio, a fifth gesture may indicate feedback to lower a lighting level, and so forth. In some examples, the audio may be requested to vote on whether to make a particular adjustment to the playback of the audio and/or the lighting by making a particular gesture, by standing at a particular area, or by dancing in a particular style, among other examples. As an example, audience members may vote for the audio to be a first genre by standing to a left side of the physical area, and other audience members may vote for the audio to be a second genre by standing to a right side of the physical area.

In a similar manner as described above, the control device may obtain a sequence of images, and the control device may extract one or more images, from the sequence of images, that depict one or more people present at the physical area In a similar manner as described above, the control device may provide the one or more images to a machine learning model (e.g., the same machine learning model described above, or a different machine learning model), and the machine learning model may perform computer vision processing of the one or more images. In some implementations, the machine learning model may be trained to identify, in the one or more images, gestures being made by the one or more people. For example, the machine learning model may identify whether one or more particular gestures are being made or a quantity of people that have made each particular gesture (e.g., concurrently or within a particular time window). Additionally, or alternatively, the machine learning model may identify standing locations of the one or more people. For example, the machine learning model may identify votes of the one or more people based on the standing locations. Additionally, or alternatively, the machine learning model may identify dancing styles of the one or more people. For example, the machine learning model may identify votes of the one or more people based on the dancing styles.

An output of the machine learning model (e.g., of the computer vision processing) may indicate one or more gestures that are identified, a quantity of each gesture that is identified, and/or one or more votes that are identified. In a similar manner as described above, the control device may cause an adjustment to the playback of the audio and/or the lighting. For example, the control device may cause the adjustment to the playback of the audio and/or the lighting based on the output of the machine learning model (e.g., of the computer vision processing). In some implementations, the control device may cause the adjustment to the playback of the audio and/or the lighting based on a particular gesture being identified, based on a threshold quantity of the particular gesture being identified, and/or based on a quantity of votes (e.g., a majority quantity of votes or a threshold quantity of votes) identified.

Techniques described above relating to audio adjustment may be adapted for use for lighting adjustment, and techniques described above relating to lighting adjustment may be adapted for use for audio adjustment. Furthermore, techniques described above relating to adjustment of the playback of audio may be adapted for use in adjustment of the playback of live audio.

As indicated above, FIGS. 1A-1D are provided as an example. Other examples may differ from what is described in connection with FIGS. 1A-1D.

FIG. 2 is a diagram of an example environment 200 in which systems and/or methods described herein may be implemented. As shown in FIG. 2, environment 200 may include a control device 210, a speaker 220, a lighting device 230, a camera 240, a remote device 250, and a network 260. Devices of environment 200 may interconnect via wired connections, wireless connections, or a combination of wired and wireless connections.

The control device 210 may include one or more devices capable of receiving, generating, storing, processing, and/or providing information associated with audio or lighting adjustment, as described elsewhere herein. The control device 210 may include a communication device and/or a computing device. For example, the control device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. Additionally, or alternatively, the control device 210 may include a server, such as an application server, a client server, a web server, a host server, a proxy server, a virtual server (e.g., executing on computing hardware), or a server in a cloud computing system.

The speaker 220 may include one or more speakers capable of outputting sound based on an audio signal. The speaker 220 may include a communication device and/or a computing device. The lighting device 230 may include one or more light emitting devices. For example, the lighting device 230 may include one or more spotlights, one or more strobe lights, one or more moving-head lights, or the like. The lighting device 230 may include a communication device and/or a computing device. The camera 240 may include one or more devices capable of capturing a digital image. The camera 240 may include a communication device and/or a computing device. In some implementations, the control device 210 may include, may be included in, or may be included in a system with, the camera 240.

The remote device 250 may include one or more devices capable of receiving, generating, storing, processing, providing, and/or routing information associated with a machine learning model. The remote device 250 may include a communication device and/or a computing device. For example, the remote device 250 may include a server, such as an application server, a client server, a web server, a database server, a host server, a proxy server, a virtual server (e.g., executing on computing hardware), or a server in a cloud computing system. In some implementations, the remote device 250 may include computing hardware used in a cloud computing environment.

The network 260 may include one or more wired and/or wireless networks. For example, the network 260 may include a wireless wide area network (e.g., a cellular network or a public land mobile network), a local area network (e.g., a wired local area network or a WLAN, such as a Wi-Fi network), a personal area network (e.g., a Bluetooth network), a near-field communication network, a telephone network, a private network, the Internet, and/or a combination of these or other types of networks. The network 260 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with audio playback adjustment. The device 300 may correspond to control device 210, speaker 220, lighting device 230, camera 240, and/or remote device 250. In some implementations, control device 210, speaker 220, lighting device 230, camera 240, and/or remote device 250 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

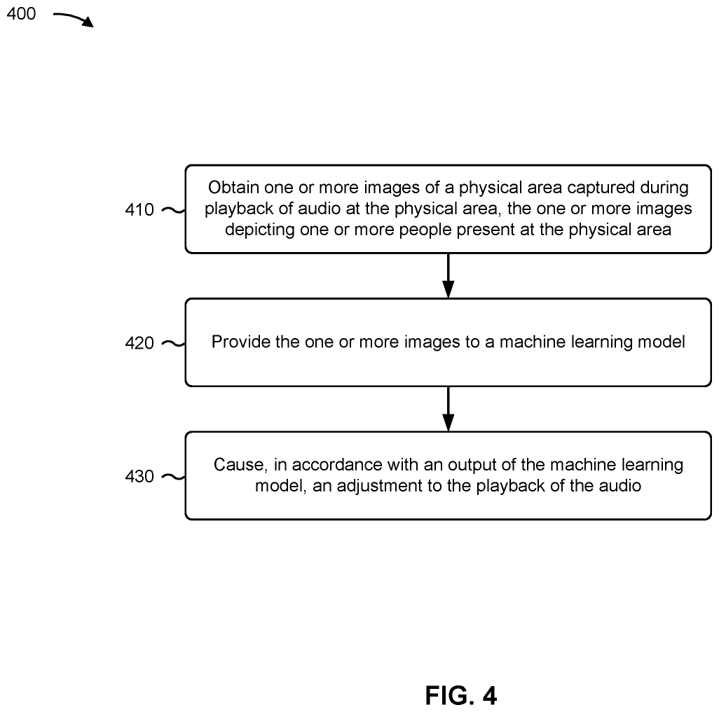

FIG. 4 is a flowchart of an example process 400 associated with audio or lighting adjustment based on images. In some implementations, one or more process blocks of FIG. 4 may be performed by the control device 210.

As shown in FIG. 4, process 400 may include obtaining one or more images of a physical area captured during playback of audio at the physical area, the one or more images depicting one or more people present at the physical area (block 410). For example, the control device 210 (e.g., using processor 320, memory 330, and/or communication component 360) may obtain one or more images of a physical area captured during playback of audio at the physical area, as described herein.

As shown in FIG. 4, process 400 may include providing the one or more images to a machine learning model (block 420). For example, the control device 210 (e.g., using processor 320, memory 330, and/or communication component 360) may provide the one or more images to a machine learning model, as described herein.

As shown in FIG. 4, process 400 may include causing, in accordance with an output of the machine learning model, an adjustment to the playback of the audio (block 430). For example, the control device 210 (e.g., using processor 320, memory 330, and/or communication component 360) may cause, in accordance with an output of the machine learning model, an adjustment to the playback of the audio, as described herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. For example, process 400 may be additionally, or alternatively, applicable to lighting adjustment.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

A set of functions described herein as being performed by a processor or by one or more processors may be performed individually by a single processor or may be performed collectively by multiple processors (e.g., one or more first functions may be performed by one or more first processors and one or more second functions may be performed by one or more second processors). A set of functions described herein as being performed by a machine learning model or by one or more machine learning models may be performed individually by a single machine learning model or may be performed collectively by multiple machine learning models (e.g., one or more first functions may be performed by one or more first machine learning models and one or more second functions may be performed by one or more second machine learning models).

What is claimed is:

1. A system, comprising:
one or more speakers;
one or more cameras; and
a control device, configured to:
obtain a sequence of multiple images of a physical area captured by the one or more cameras during playback of audio, via the one or more speakers, at the physical area;
extract one or more images from the sequence of multiple images,
the one or more images depicting one or more people present at the physical area;
provide the one or more images to a machine learning model,
the machine learning model trained to determine a change of a volume of the audio, a change of a tempo of the audio, a change of a genre of the audio, or a change of an audio track of the audio based on an input of the one or more images; and
transmit a signal for the one or more speakers to cause the one or more speakers to output an adjustment to the playback of the audio that is based on an output of the machine learning model.

2. The system of claim 1, wherein the sequence of multiple images is a live video feed of the physical area.

3. The system of claim 1, wherein the machine learning model is trained to identify, in the one or more images, at least one of:
a crowd density of the one or more people,
movement intensity levels of the one or more people,
interaction proximities between the one or more people, or
facial expression-based sentiments of the one or more people.

4. The system of claim 1, further comprising:
one or more lighting devices,
wherein the machine learning model is further trained to determine a change to lighting based on the input of the one or more images, and
wherein the control device is further configured to:
transmit an additional signal for the one or more lighting devices to cause the one or more lighting devices to adjust the lighting at the physical area based on the output of the machine learning model.

5. A method, comprising:
obtaining, by a device, a sequence of images of a physical area, at least one image of the sequence of images captured during playback of audio at the physical area and depicting one or more people present at the physical area;
generating, by the device, a signal in accordance with an output of computer vision processing of the at least one image; and
providing, by the device, the signal to audio output hardware to cause an adjustment to the playback of the audio.

6. The method of claim 5, wherein the adjustment to the playback of the audio is a change of a volume of the audio.

7. The method of claim 5, wherein the adjustment to the playback of the audio is switching from a first audio track to a second audio track.

8. The method of claim 5, wherein the adjustment to the playback of the audio is a change of tempo of the audio.

9. The method of claim 5, wherein the physical area is a dance floor.

10. The method of claim 5, wherein the sequence of images is a live video feed.

11. The method of claim 5, wherein the computer vision processing of the at least one image uses a machine learning model trained to identify, in the at least one image, at least one of:
a crowd density of the one or more people,
movement intensity levels of the one or more people,
interaction proximities between the one or more people, or
facial expression-based sentiments of the one or more people.

12. The method of claim 5, wherein the computer vision processing of the at least one image uses a machine learning model trained to determine a change of a volume of the audio, a change of a tempo of the audio, a change of a genre of the audio, or a change of an audio track of the audio based on an input of the at least one image.

13. A device, comprising:
one or more memories; and
one or more processors, coupled to the one or more memories, configured to:
obtain one or more images of a physical area captured during audio output through a speaker at the physical area,
the one or more images depicting one or more people present at the physical area; and
cause, based on the one or more images, an adjustment to at least one of the audio output or a lighting at the physical area.

14. The device of claim 13, wherein the adjustment is to the audio output.

15. The device of claim 13, wherein the one or more processors are further configured to:
provide the one or more images to a machine learning model, and wherein the one or more processors, to cause the adjustment, are configured to:
cause the adjustment to at least one of the audio output or the lighting at the physical area based on an output of the machine learning model.

16. The device of claim 15, wherein the machine learning model is trained to identify, in the one or more images, at least one of:
a crowd density of the one or more people,
movement intensity levels of the one or more people,
interaction proximities between the one or more people, or
facial expression-based sentiments of the one or more people.

17. The device of claim 15, wherein the machine learning model is trained to determine a change of a volume of the audio output, a change of a tempo of the audio output, a change of a genre of the audio output, or a change of an audio track of the audio output based on an input of the one or more images.

18. The device of claim 13, wherein the audio output is playback of audio.

19. The device of claim 13, wherein the adjustment to the audio output is a change of a volume of the audio output or switching from a first audio track to a second audio track.

20. The device of claim 13, wherein the one or more processors, to cause the adjustment, are configured to:
generate a signal for one or more speakers to cause the adjustment to the audio output.
